(19) United States
(12) Patent Application Publication
(10) Pub. No.: US 2004/0095409 A1
(43) Pub. Date: May 20, 2004

(54) Apparatus and method for determining status of inkjet print head identification circuit

(76) Inventors: Hung-Lieh Hu, Hsinchu City (TW); Chieh-Wen Wang, Hsinchu City (TW); Linyean Lin, Dadu Township (TW)

Correspondence Address: J.C. Patents, Inc., Suite 250, 4 Venture, Irvine, CA, 92618, US

(21) Appl. No.: 10/704,488

(22) Filed: Nov. 6, 2003

(30) Foreign Application Priority Data
Nov. 11, 2002 (TW) 91133431
Mar. 13, 2003 (TW) 92105458
Jul. 25, 2003 (TW) 92120595

(51) Int. Cl. B41J 29/393

(52) U.S. Cl. 347/19

(57) ABSTRACT

An apparatus and a method for determining status of inkjet print head identification circuit are provided for an inkjet print head with a plurality of signal lines. The apparatus comprises: a status output terminal outputting one bit data of the status of the inkjet print head identification circuit; a first blowing terminal electrically coupled to the status output terminal via a first programmable switch; and a second blowing terminal electrically coupled to the status output terminal via a second programmable switch; wherein one of the first programmable switch and the second programmable switch being off to determine a voltage level of the status output terminal.

### CROSS-REFERENCE TO RELATED APPLICATION

This application claim the priority benefit of Taiwan application serial nos. 91133431, filed on Nov. 11, 2002; 92105458, filed on Mar. 13, 2003; 92120595, filed on Jul. 25, 2003.

### BACKGROUND OF THE INVENTION

1. Field of the Invention

This invention generally relates to an inkjet print head, and more particularly to an apparatus and method for determining statuses of inkjet print head identification circuit.

2. Description of the Related Art

As the technology advances, more and more computer peripherals have been developed. Taking the inkjet printer as an example, to meet the different print requirements, several inkjet printers have been developed. Each inkjet printer has its specific inkjet print heads. The function of the inkjet print head is to spray the ink from the nozzle. There are two types of inkjet print heads—continuous and drop-on-demand type respectively—based on the different droplet ejection principles. To implement the different droplet ejection principles, each inkjet print head has its own structure, such as one inkjet print head for black ink and one inkjet print head for color ink, or inkjet print heads with different numbers of nozzles. For the purpose of identifying each inkjet print head, an identification code corresponding to the specific inkjet print head will be written into the print head. Hence, the inkjet printer can control the inkjet print head according to the identification code for printing works.

As mentioned above, the inkjet printer has to identify the type of the inkjet print head. Hence, an identification circuit is required in the inkjet print head for the inkjet printer to read the identification code. This identification circuit will be used when the inkjet print head is installed for the first time in the inkjet printer. After the inkjet printer identifies the inkjet print head, the identification circuit will not be used. Hence, the identification circuit will read the identification code via the signal lines for controlling the print head array circuit.

### SUMMARY OF THE INVENTION

An object of the present invention is to provide an apparatus and method for determining statuses of inkjet print head identification circuit. The identification circuit can acquire the complete identification code without the limitation of the number of the signal lines. The apparatus provided by the present invention is suitable for an inkjet print head with a plurality of signal lines, comprising: a status output terminal for outputting a one bit data of the status of the inkjet print head identification circuit; a first blowing terminal electrically coupled to the status output terminal via a first programmable switch; and a second blowing terminal electrically coupled to the status output terminal via a second programmable switch; and a switch circuit controlled by the signal lines for conducting an external power supply to program the first and second programmable switches.

In a preferred embodiment of the present invention, the switch circuit comprises: a first transistor, a first signal line of the plurality of signal lines determining whether to turn on/off the first transistor; and a second transistor, wherein when the first transistor is on, the voltage level of a second signal line of the plurality of signal lines determines whether to apply the external power supply to the first programmable switch and the second programmable switch. The first signal line may be or may not be the second signal line. The first and second switches include fuses or low-power resistor to store data bit 0 or 1 used for identification code output by inkjet print head.

In another embodiment of the present invention, the apparatus further comprises a status input circuit having a third blowing terminal, the status input circuit being electrically coupled to the plurality of signal lines, the status input circuit being controlled by the plurality of signal lines to conduct the external power supply to the third blowing terminal. The status input circuit further comprises: a third transistor, a third signal line of the plurality of signal lines for determining whether to turn on/off the third transistor; and a fourth transistor, when the third transistor is on, the voltage level of a fourth signal line of the plurality of signal lines determines whether to apply the external power supply to the third blowing terminal. The third signal line may be or may not be the fourth signal line. The first, second, third and fourth signal lines can be the same signal line or different.

The present invention also provides a method of determining statuses of inkjet print head identification circuit, for an inkjet print head with a plurality of signal lines, comprising: enabling two of the plurality of signal lines to conduct an external power supply; and coupling the external power supply to a first programmable switch and a second programmable switch which are electrically coupled to different voltages respectively, to turn off one of the first programmable switch and a second programmable switch; wherein the plurality of signal lines are not enabled simultaneously when the inkjet print head operates.

In another embodiment of the present invention, the step of coupling the external power supply to the first programmable switch and the second programmable switch comprises: floating one terminal of one of the first programmable switch and the second programmable switch, and applying the external power supply to another terminal of the one of the first programmable switch and the second programmable switch; and grounding one terminal of another first programmable switch and the second programmable switch, and applying the external power supply to another terminal of the other first programmable switch and the second programmable switch; wherein the grounded first programmable switch and the second programmable switch is off due to a voltage difference between the one terminal and the another terminal.

The present invention uses a pair of fuses or low power resistors less than approximately 0.3 W, or uses a fuse and a low power resistor less than approximately 0.3 W. The status output terminal will output 1 or 0 based on which one of the fuses (or resistors, or a fuse and a resistor) is blown. The apparatus provided by the present invention can be controlled by the signal line to determine which one of the fuses (or resistors, or a fuse and a resistor) is going to be blown, and receive the applied power supply to blow the fuse.

The above is a brief description of some deficiencies in the prior art and advantages of the present invention. Other features, advantages and embodiments of the invention will be apparent to those skilled in the art from the following description, accompanying drawings and appended claims. It is intended that the scope of the invention be limited by the claims and not by the preceding summary or the following detailed description.

### BRIEF DESCRIPTION OF THE DRAWINGS

FIG. 1 is a block diagram of an identification system of an inkjet printer.

FIG. 2 is a conventional identification circuit of an inkjet print head.

FIG. 3 is another conventional identification circuit of an inkjet print head.

FIG. 4 is still another conventional identification circuit of an inkjet print head.

FIG. 5 is a timing sequence of the conventional identification circuit of an inkjet print head of FIG. 4.

FIG. 6 is further another conventional identification circuit of an inkjet print head.

FIG. 7A is an apparatus for determining the status of a one bit identification circuit of an inkjet print head in accordance with the first preferred embodiment of the present invention.

FIG. 7B is an apparatus for determining the status of a one bit identification circuit of an inkjet print head in accordance with another preferred embodiment of the present invention.

FIG. 7C shows how the status output terminal 605 outputs one bit data of the status of the inkjet print head identification circuit to the corresponding input terminal 605′″ of one-bit shift registers.

FIG. 8A is an apparatus for determining the status of a one bit identification circuit of an inkjet print head in accordance with the second preferred embodiment of the present invention.

FIG. 8B shows the apparatus of FIG. 8A connected to the circuit of FIG. 4.

### DESCRIPTION OF THE PREFERRED EMBODIMENTS

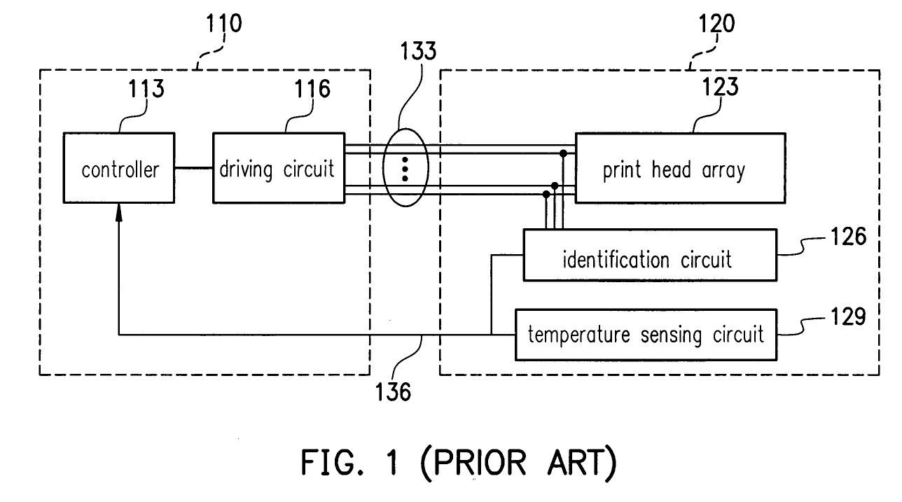

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention. Before illustrating the present invention, to make one skilled in the art understanding the present invention, the structure of the current inkjet print head is described. FIG. 1 is a block diagram of an identification system of an inkjet printer. As shown in FIG. 1, the identification system includes a printer electronic 110 connected to the signal lines 133 and the temperature sensing output line 136, and a print head electronic 120. The printer electronic 110 includes the controller 113 and the driving circuit 116. The print head electronic 120 includes the print head array 123, the identification circuit 126 and the temperature sensing circuit 129.

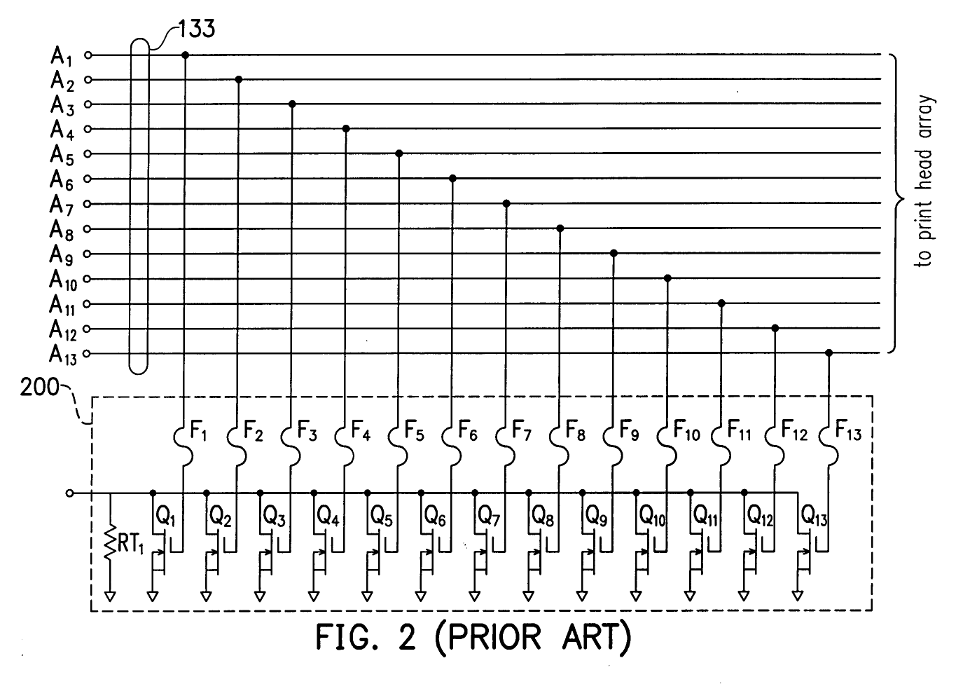

The identification circuit 126 can be the one that has been disclosed in U.S. Pat. No. 5,363,134 as shown in FIG. 2. The identification circuit 200 uses plurality of fuses F1-F13 connected to the gates of a plurality of transistors Q1-Q13, respectively, to control the turning on of the transistors Q1-Q13. The identification code of the inkjet print head is stored by programming the fuses F1-F13. For example, assuming that the high level reading signal is sent via A13, if the fuse F13 is not blown, the transistor Q13 will be turned on. Hence, the temperature sensing output line 136 will be pulled to a low level and the data bit is “0”. If the fuse F13 is blown, the transistor Q13 is turned off. Hence, the temperature sensing output line 136 will be pulled to high level and the data bit is “1”. The other lines can also be read by the same way. However, each signal line of the identification circuit can only represent one bit. Hence, the number of bits for the identification code will be limited by the number of the signal lines.

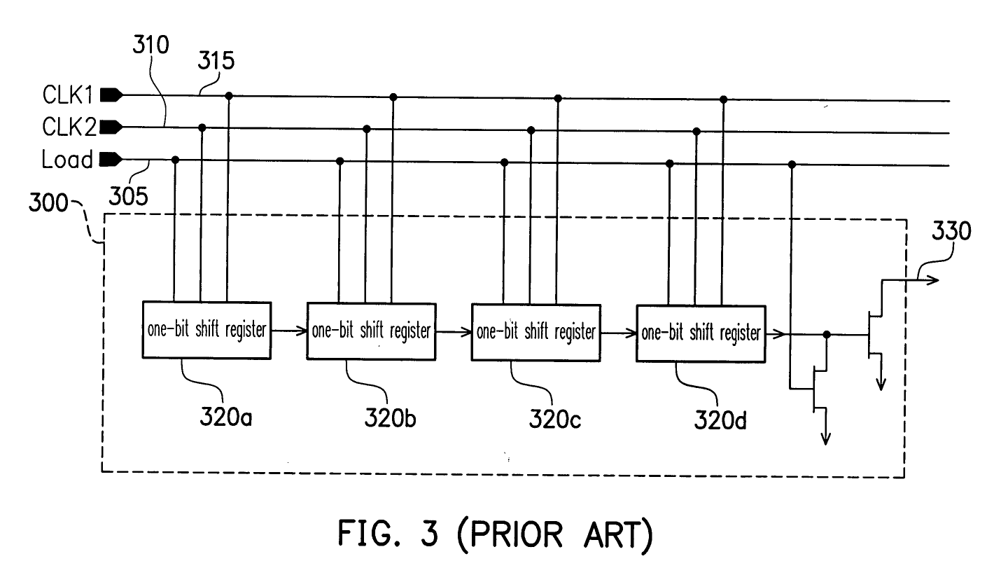

To overcome this drawback, U.S. Pat. No. 5,940,095 discloses another identification circuit as shown in FIG. 3. The identification circuit 300 uses a plurality of one-bit mask programmed shift registers 320a-320d to implement the parallel-in-series-out identification circuit. The printer electronic 110 sends the control signal “Load” via the signal line 305, and the identification code was stored into the one-bit mask programmed shift registers 320a-320d. Those shift registers are dynamic shift registers. When the first clock signal CLK1 and the second clock signal CLK2 are received via the signal lines 310 and 315, the data bit stored in the one-bit mask programmed shift register 320d will be shifted out via the signal line 330. The data bit stored in the one-bit mask programmed shift register 320c will be shifted out to the one-bit mask programmed shift register 320d. The data bit stored in the one-bit mask programmed shift register 320b will be shifted out to the one-bit mask programmed shift register 320c. The data bit stored in the one-bit mask programmed shift register 320a will be shifted out to the one-bit mask programmed shift register 320b. Then the printer electronic 110 sends the control signal “Load” via the signal line 305, and sends the signal CLK1 and the second clock signal CLK2 via the signal lines 310 and 315. Then the identification code stored in the one-bit mask programmed shift registers 320a-320d will be serially outputted. Hence, this parallel-in-series-out identification circuit only requires three signal lines 305, 310, and 315 to read the identification code without the limitation of the number of the signal lines. It should be noted that this identification circuit is fabricated by mask programming. Hence the identification code is determined during the chip fabrication and cannot be changed later on.

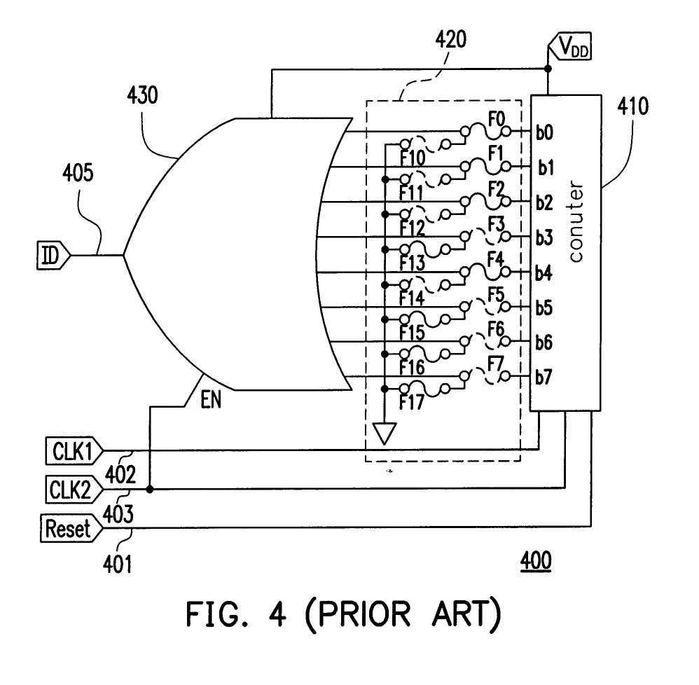

FIG. 4 is still another conventional identification circuit of an inkjet print head. The identification circuit 420 includes the counter 410, OR logic unit 430, and the programmable unit 420 consisting of fuses. The identification circuit 420 only requires four signal lines including a reset signal line 401 for transmitting Reset signal, a first clock signal line 402 for transmitting CLK1 signal, a second clock signal line 403 for transmitting CLK2 signal, and an identification code signal line 405 for transmitting ID signal. Hence, this identification circuit can expand the bit number based on the identification code and will not be limited by the number of the signal lines.

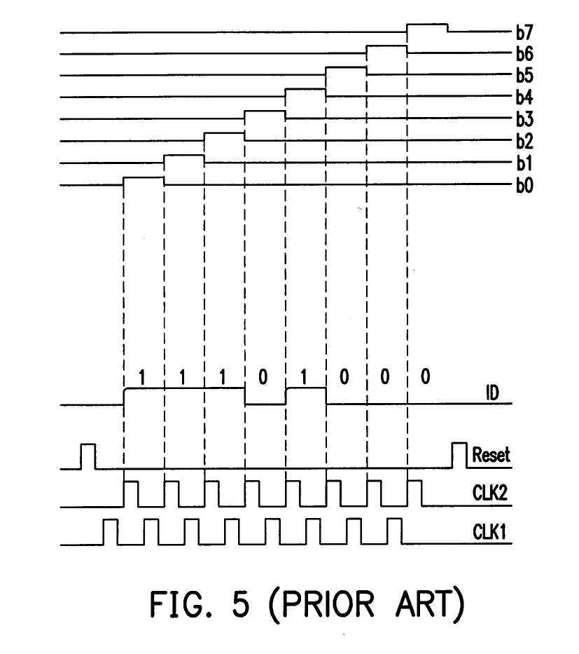

The counter 410 is electrically coupled to the reset signal 401, the first clock signal line 402 and the second clock signal line 403. The counter 410 is an 8-bit counter with 8 output terminals b0-b7 for required number of identification codes. Each of output terminals b0-b7 is connected to the input terminals of the OR gate unit 430 via the fuses of the programmable unit 420. The input terminals of the OR gate unit 430 is electrically connected to the ground via the fuses of the programmable unit 420. Further, the OR gate unit 430 includes an enable terminal EN to receive the second clock signal CLK2. For example, if the identification code is 11101000, the fuses F10, F11, F12, F3, F14, F5, F6, and F7 have to be blown and the fuses F0, F1, F2, F13, F4, F15, F16, and F17 are kept intact, thereby programming the identification code into the programmable unit 420. The timing sequence is shown in FIG. 5.

When the counter 410 receives the reset signal Reset via the reset signal line 401, the counter 410 is reset to “0”. When the counter receives the first and second clock signals CLK1 and CLK2 via the first and second clock signal line 402 and 403 respectively in sequence, the output terminals b0-b7 of the counter 410 will be set to “1” in sequence as shown in FIG. 5. When b0 is “1” and b1-b7 are “0”, because the fuse F0 is intact when programming, the output terminal of the OR gate unit 430 will output the one bit data “1”. Likewise, when b1 is “1” and the other output terminals are “0”, because the fuse F1 is intact when programming, the output terminal of the OR gate unit 430 will output the one bit data “1”; when b2 is “1” and the other output terminals are “0”, because the fuse F2 is intact when programming, the output terminal of the OR gate unit 430 will output the one bit data “1”. When b3 is “1” and the other output terminals are “0”, because the fuse F3 is blown when programming, the output terminal of the OR gate unit 430 will output the one bit data “0”. Hence, the OR gate unit 430 can output the identification code 11101000 in sequence. The timing sequence is shown in FIG. 5.

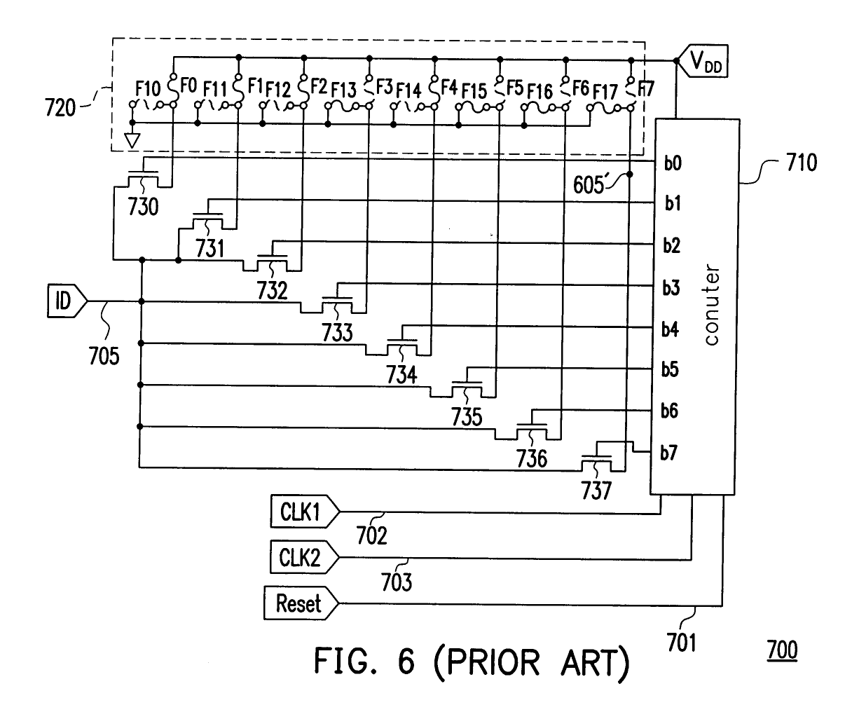

FIG. 6 is another conventional identification circuit of an inkjet print head. The identification circuit 700 includes a counter 710, a programmable unit 720 consisting of a plurality of fuses, and several NMOSFET switches 731-737.

The identification circuit 700 only requires three signal lines including a reset signal line 701 for transmitting Reset signal, a first clock signal line 702 for transmitting CLK1 signal, a second clock signal line 703 for transmitting CLK2 signal. The counter 710 is electrically coupled to the reset signal line 701, the first clock signal line 702 and the second clock signal line 703. The counter 710 is a 8-bit counter with 8 output terminals b0-b7 for required number of identification codes. Each of output terminals b0-b7 is connected to the gates of the switches 730-737 respectively to control the on/off of the switches 730-737. One of the source/drain of the switches 730-737 are connected to the power supply or ground via the fuses of the programmable unit 720 for inputting the identification code. The other source/drain of the switches 730-737 is connected to the identification code line to output the identification code.

For example, if the identification code is 11101000, the fuses F10, F11, F12, F3, F14, F5, F6, and F7 have to be blown and the fuses F0, F1, F2, F13, F4, F15, F16, and F17 are kept intact, thereby programming the identification code into the programmable unit 720. The timing sequence is shown in FIG. 5.

When the counter 710 receives the reset signal Reset via the reset signal line 701, the counter 710 is reset to “0”. When the counter receives the first and second clock signals CLK1 and CLK2 via the first and second clock signal lines 702 and 703 respectively in sequence, the output terminals b0-b7 of the counter 710 will be set to “1” in sequence as shown in FIG. 5.

When b0 is “1” and b1-b7 are “0”, because the fuse F0 is intact when programming, the switch 730 will be turned on and the one bit data “1” will be outputted. Likewise, when b1 is “1” and the other output terminals are “0”, because the fuse F1 is intact when programming, the switch 731 will be turned on and the one bit data “1” will be outputted; when b2 is “1” and the other output terminals are “0”, because the fuse F2 is intact when programming, the switch 732 will be turned on and the one bit data “1” will be outputted. When b3 is “1” and the other output terminals are “0”, because the fuse F3 is blown when programming, the switch 733 will be turned on and the one bit data “0” will be outputted. Hence, the identification code 11101000 will be outputted in sequence. The timing sequence is shown in FIG. 5.

In addition, Applicant also discloses several identification circuits in the U.S. patent application Ser. No. 10/359,578. The content of that application can also be integrated into this application for reference.

### First Embodiment

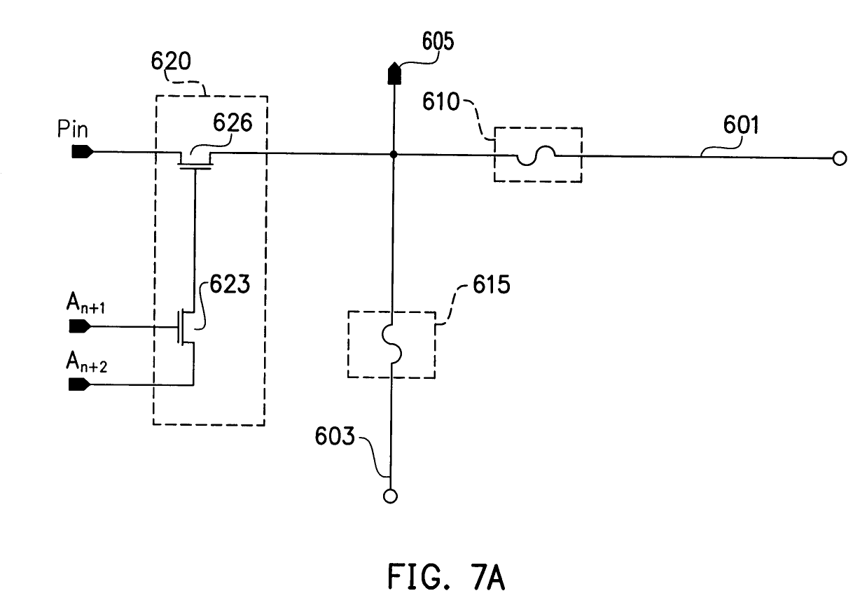

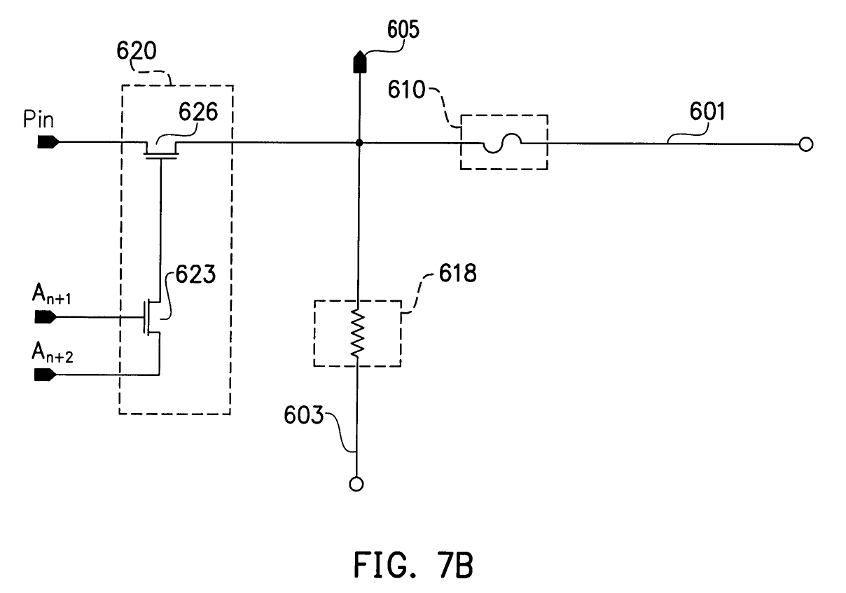

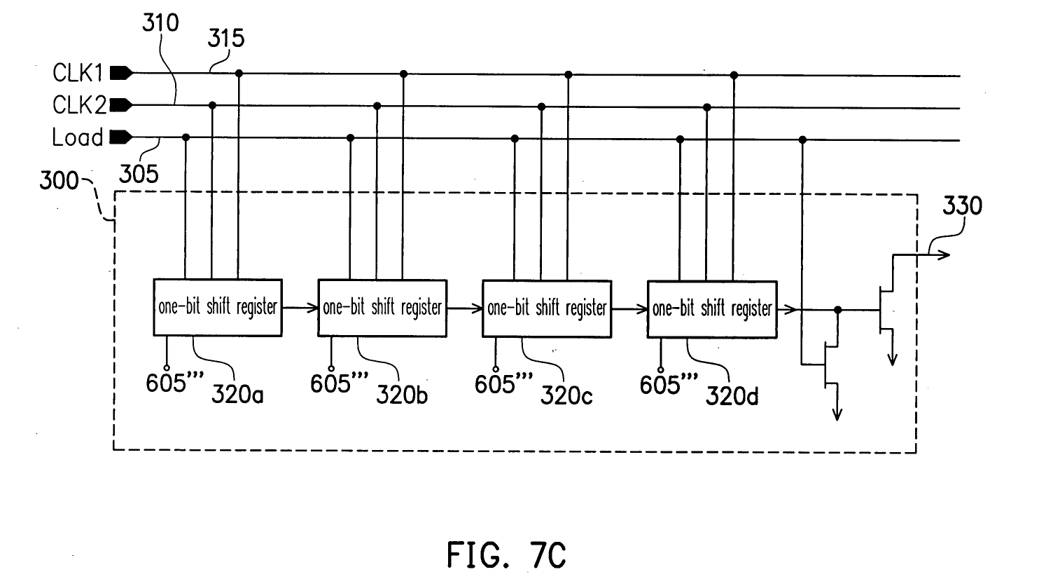

FIG. 7A is an apparatus for determining the status of one bit identification circuit of an inkjet print head in accordance with the first preferred embodiment of the present invention. The apparatus is applied to an inkjet print head as shown in FIG. 3 with a plurality of signal lines. The apparatus comprises a status output terminal 605, a first blowing terminal 601, a second blowing terminal 603, and a switch circuit 620. The status output terminal 605 outputs one bit data of the status of the inkjet print head identification circuit to the corresponding input terminal 605′″ of one-bit shift registers as exemplified in FIG. 7C. It is noted that the input terminal 605′″ of one-bit shift registers can be inside or outside the one-bit shift registers. For practical application, it can be connected to a one-bit shift register 320a-320d to provide the predetermined output for the one-bit shift register. The first blowing terminal 601 is electrically coupled to the status output terminal 605 via a first programmable switch 610. The second blowing terminal 603 is electrically coupled to the status output terminal 605 via a second programmable switch 615. The switch circuit 620 is controlled by the signal lines to conduct an external power supply Pin to program the first programmable switch 610 and said second programmable switch 615. The external power supply Pin can be a voltage supply or a current supply.

In a preferred embodiment of the present invention, the switch circuit 620 comprises a first transistor 623 and a second transistor 626. The first signal line Aₙ₊₁ determines whether to turn on/off the first transistor 623, and when the first transistor 623 is on, the voltage level of the second signal line Aₙ₊₂ determines whether to apply the external power supply Pin to the first programmable switch 610 and the second programmable switch 615. The first programmable switch 610 and the second programmable switch 615 can be fuses or low power resistors as shown in FIG. 7B.

The method to implement the embodiment mentioned above comprises the steps as follows. First, two of the signal lines, such as Aₙ₊₁ and Aₙ₊₂ will be enabled to conduct the external power supply Pin. Then the power supply Pin is used to program the first programmable switch 610 and the second programmable switch 615. By this step, one of the first programmable switch 610 and the second programmable switch 615 (such as a fuse or a low power resistor) will be blown. Hence, one of (a) the electrically connection between the first blowing terminal 601 and the status output terminal 605 and (b) the electrically connection between the second blowing terminal 603 and the status output terminal 605 is open. The first programmable switch 610 and the second programmable switch 615 are connected to the different voltage levels. To blow the second programmable switch 615, the second blowing terminal 603 connected to the second programmable switch 615 is connected to the ground and the other terminal of the second programmable switch 615 is connected to the power supply Pin. The first blowing terminal 601 connected to the first programmable switch 610 is floated, and the other terminal of the first programmable switch 610 is connected to the power supply Pin. Hence, because the second blowing terminal 603 is grounded, the second programmable switch 603 will be blown due to the voltage difference so that the connection between the second blowing terminal 603 and the status output terminal 605 is broken.

Likewise, to blow the first programmable switch 610, the first blowing terminal 601 connected to the first programmable switch 610 is connected to the ground and the other terminal of the first programmable switch 610 is connected to the power supply Pin. The second blowing terminal 603 connected to the second programmable switch 615 is floated, and the other terminal of the second programmable switch 615 is connected to the power supply Pin. Hence, because the first blowing terminal 601 is grounded, the first programmable switch 615 will be blown due to the voltage difference so that the connection between the first blowing terminal 601 and the status output terminal 605 is broken.

It should be noted that when the inkjet print head operates under normal condition, the first blowing terminal 601 is connected to the operational voltage V_{DD}, and the second blowing terminal 603 is connected to the ground. If the first programmable switch 610 is blown, the output is “0” as the one bit of the identification code. If the second programmable switch 615 is blown, the output is “1” as the one bit of the identification code.

### Second Embodiment

The apparatus shown in FIGS. 7A and 7B can also be applied to the identification circuit of FIG. 6. The first programmable switch and the second programmable switch can be deemed a pair of fuses (e.g., F0 and F10, F1 and F11, F2 and F12, F3 and F13, F4 and F14, F5 and F15, F6 and F16, and F7 and F17) of FIG. 6. Taking F7 and F17 as an example, the status output terminal of FIG. 7 is connected to the logic gate input terminal 605′ of FIG. 6. The first programmable switch is F7, and the second programmable switch is F17. Hence, to blow one of the fuses, it can be performed as follows: First, two of the signal lines, such as Aₙ₊₁ and Aₙ₊₂ will be enabled to conduct the external power supply Pin. Then the power supply Pin is used to program the first programmable switch 610 and the second programmable switch 615. By this step, one of the first programmable switch 610 and the second programmable switch 615 (such as a fuse or a low power resistor) will be blown. Hence, one of (a) the electrically connection between the first blowing terminal 601 and the status output terminal 605 and (b) the electrically connection between the second blowing terminal 603 and the status output terminal 605 is open. The first programmable switch 610 and the second programmable switch 615 are connected to the different voltage levels. To blow the second programmable switch 615, the second blowing terminal 603 connected to the second programmable switch 615 is connected to the ground and the other terminal of the second programmable switch 615 is connected to the power supply Pin. The first blowing terminal 601 connected to the first programmable switch 610 is floated, and the other terminal of the first programmable switch 610 is connected to the power supply Pin. Hence, because the second blowing terminal 603 is grounded, the second programmable switch 615 will be blown due to the voltage difference so that the connection between the second blowing terminal 603 and the status output terminal 605 is broken.

Likewise, to blow the first programmable switch 610, the first blowing terminal 601 connected to the first programmable switch is connected to the ground and the other terminal of the first programmable switch 610 is connected to the power supply Pin. The second blowing terminal 603 connected to the second programmable switch 615 is floated, and the other terminal of the second programmable switch 615 is connected to the power supply Pin. Hence, because the first blowing terminal 601 is grounded, the first programmable switch 610 will be blown due to the voltage difference so that the connection between the first blowing terminal 601 and the status output terminal 605 is broken.

When the inkjet print head operates under normal condition, the first blowing terminal 601 is connected to the operational voltage V_{DD}, and the second blowing terminal 603 is connected to the ground. If the first programmable switch 610 is blown, the output is “0” as the one bit of the identification code. If the second programmable switch 615 is blown, the output is “1” as the one bit of the identification code.

### Third Embodiment

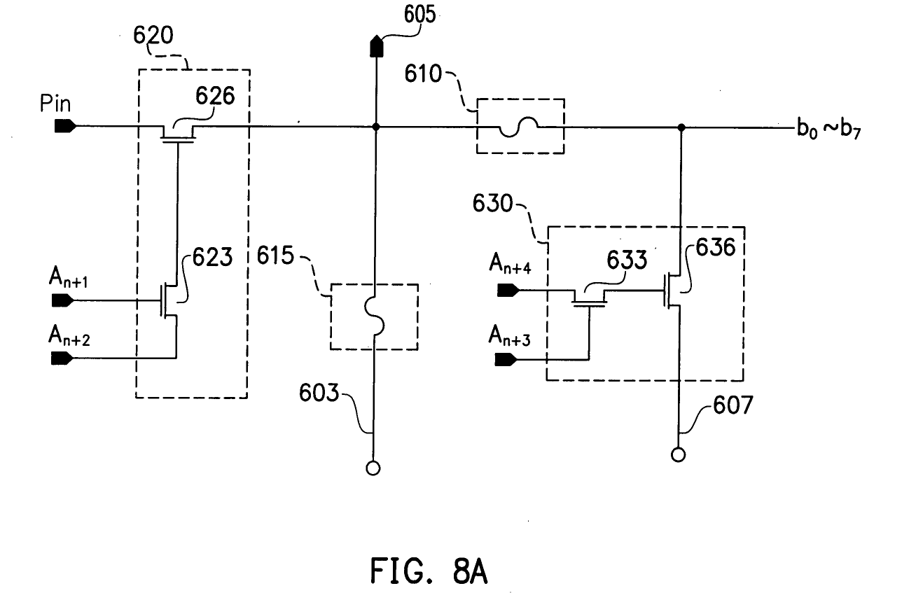

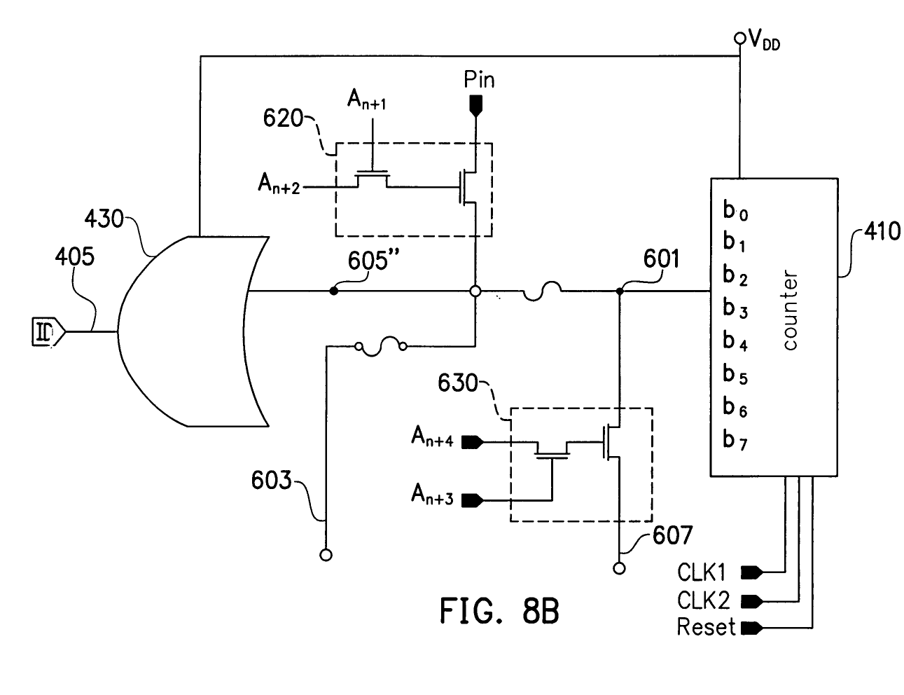

FIG. 8A is an apparatus for determining the status of one bit identification circuit of an inkjet print head in accordance with the third preferred embodiment of the present invention. This apparatus can be applied to the one-bit identification circuit of FIG. 4. Compared to the first embodiment, this embodiment further includes a status input circuit 630. The status input circuit 630 is controlled by the signal lines Aₙ₊₃ and Aₙ₊₄ to conduct the external power supply to the third blowing point 607. The status input circuit 630 includes a third transistor 633 and a fourth transistor 636. The third signal line Aₙ₊₃ determines whether to turn on/off the third transistor 633. When the third transistor 633 is on, the voltage level of the fourth signal line Aₙ₊₄, determines whether to apply the external power supply to the third blowing terminal 607. The first, second, third, and fourth signal lines can be the same signal line or different signal lines.

FIG. 8B shows the apparatus of FIG. 8A connected to the circuit of FIG. 4, wherein the status output terminal 605 is coupled to the corresponding input terminal 605′″ of the OR gate

To blow one of the first and second programmable switches 610, 615, first, two of the signal lines, such as Aₙ₊₁ and Aₙ₊₂ will be enabled to conduct the external power supply Pin. Then the power supply Pin is used to program the first programmable switch 610 and the second programmable switch 615. By this step, one of the first programmable switch 610 and the second programmable switch 615 (such as a fuse or a low power resistor) will be blown. Hence, one of (a) the electrically connection between the second blowing terminal 603 and the status output terminal 605 and (b) the electrically connection between the third blowing terminal 607 and the status output terminal 605 is open. The first programmable switch 610 and the second programmable switch 615 are connected to the different voltage levels. To blow the second programmable switch 615, the second blowing terminal 603 connected to the second programmable switch 615 is connected to the ground and the other terminal of the second programmable switch 615 connected to the power supply Pin. The third blowing terminal 607 connected to the first programmable switch 610 is floated, and the other terminal of the first programmable switch 610 is connected to the power supply Pin. Hence, because the second blowing terminal 603 is grounded, the second programmable switch 615 will be blown due to the voltage difference so that the connection between the second blowing terminal 603 and the status output terminal 605 is broken.

Likewise, to blow the first programmable switch 610, the third blowing terminal 607 connected to the first programmable switch 610 is connected to the ground and the other terminal of the first programmable switch 610 is connected to the power supply Pin. The second blowing terminal 603 connected to the second programmable switch 615 is floated, and the other terminal of the second programmable switch 615 is connected to the power supply Pin. Hence, because the first blowing terminal 601 is grounded, the first programmable switch 610 will be blown due to the voltage difference so that the connection between the third blowing terminal 607 and the status output terminal 605 is broken.

It should be noted when the inkjet print head operates under normal condition, the third blowing terminal 607 is floated and the second blowing terminal is connected to the ground. If the first programmable switch 610 is blown, the output is “O” as the one bit of the identification code. If the second programmable switch 615 is blown, the status output terminal 605 is electrically coupled to the output terminals b0-b7 of the counter so that the voltage level of the status output terminal 605 is the same as the output terminals b0-b7 of the counter.

Further, when the printer prints the works, no more than two signal lines will be enabled. Only when blowing the fuses and storing the identification code, more than two signal lines can be enabled.

The present invention uses a pair of fuses or low power resistors approximately less than 0.3 W, or uses a fuse and a low power resistor approximately less than 0.3 W. The status output terminal 605 will output 1 or 0 based on which one of the fuses (or resistors, or a fuse and a resistor) is blown by applying an external power supply Pin. The identification circuit of the present invention is programmable by inputting signals and external power supply for blowing the fuse. The identification circuit of the present invention uses programmable fuses or low power resistors to change the identification code. Hence, it provides flexibility by using the existent signal line pins to blow the fuses without additional pins. Hence the present invention can be used for mass production because it is much simpler than the conventional identification circuit.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. It should be appreciated that variations may be made in the embodiments described by workers skilled in the art without departing from the scope of the present invention as defined by the following claims. Moreover, no element, component, nor method step in the present disclosure is intended to be dedicated to the public regardless of whether the element, component, or method step is explicitly recited in the following claims.

What is claimed is:

1. An apparatus for determining statuses of an identification circuit of an inkjet print head with a plurality of signal lines, wherein said identification circuit having at least one input terminal, comprising:
a status output terminal, outputting one bit data of said status of said inkjet print head identification circuit to said at least one input terminal corresponding to said status output terminal;
a first blowing terminal, electrically coupled to said status output terminal via a first programmable switch; and
a second blowing terminal, electrically coupled to said status output terminal via a second programmable switch;
wherein one of said first programmable switch and said second programmable switch being off to determine a voltage level of said status output terminal.

2. The apparatus of claim 1, further comprising a switch circuit, controlled by said plurality of said signal lines, conducting an external power supply to program said first programmable switch and said second programmable switch.

3. The apparatus of claim 2, wherein said switch circuit comprises:
a first transistor, a first signal line of said plurality of signal lines determining whether to turn on/off said first transistor; and
a second transistor, wherein when said first transistor is on, the voltage level of a second signal line of said plurality of signal lines determines whether to apply said external power supply to said first programmable switch and said second programmable switch.

4. The apparatus of claim 3, wherein said first signal line is said second signal line.

5. The apparatus of claim 1, wherein said first and second programmable switches include fuses.

6. The apparatus of claim 1, further comprising a status input circuit having a third blowing terminal, said status input circuit being electrically coupled to said plurality of signal lines, said status input circuit being controlled by said plurality of signal lines to conduct said external power supply to said third blowing terminal.

7. The apparatus of claim 6, wherein said status input circuit further comprises:
a third transistor, a third signal line of said plurality of signal lines determining whether to turn on/off said third transistor; and
a fourth transistor, wherein when said third transistor is on, the voltage level of a fourth signal line of said plurality of signal lines determines whether to apply said external power supply to said third blowing terminal.

8. The apparatus of claim 7, wherein said third signal line is said fourth signal line.

9. The apparatus of claim 3, further comprising a status input circuit having a third blowing terminal, said status input circuit being electrically coupled to said plurality of signal lines, said status input circuit being controlled by said plurality of signal lines to conduct said external power supply to said third blowing terminal.

10. The apparatus of claim 9, wherein said status input circuit further comprises:
a third transistor, a third signal line of said plurality of signal lines determining whether to turn on/off said third transistor; and
a fourth transistor, wherein when said third transistor is on, the voltage level of a fourth signal line of said plurality of signal lines determines whether to apply said external power supply to said third blowing terminal.

11. The apparatus of claim 10, wherein said first, second, third, and fourth signal lines are a same signal line.

12. The apparatus of claim 1, wherein said inkjet print head identification circuit includes a shift register.

13. The apparatus of claim 1, wherein said inkjet print head identification circuit includes a counter.

14. The apparatus of claim 13, wherein said inkjet print head identification circuit includes a logic gate.

15. A method of determining a status of an identification circuit of an inkjet print head with a plurality of signal lines, comprising:
enabling two of said plurality of signal lines to conduct an external power supply; and
coupling said external power supply to a first programmable switch and a second programmable switch to turn off one of said first programmable switch and a second programmable switch;
wherein said plurality of signal lines are not enabled simultaneously when said inkjet print head operates.

16. The method of claim 15, wherein said step of coupling said external power supply to said first programmable switch and said second programmable switch comprises:
floating one terminal of one of said first programmable switch and said second programmable switch, and applying said external power supply to another terminal of said one of said first programmable switch and said second programmable switch; and
grounding one terminal of the other first programmable switch and said second programmable switch, and applying said external power supply to another terminal of said other first programmable switch and said second programmable switch;
wherein said grounded first programmable switch and said second programmable switch is off due to a voltage difference between said one terminal and said another terminal.

17. The method of claim 15, wherein two of said plurality of signal lines are same signal line.

18. The apparatus of claim 1, wherein said first programmable switch and said second programmable switch include low power resistors.

19. The apparatus of claim 1, wherein one of said first programmable switch and said second programmable switch is a low power resistor.
